(19) United States
(12) Patent Application Publication
(10) Pub. No.: US 2022/0312812 A1
(43) Pub. Date: Oct. 6, 2022

(54) COMPOSITIONS COMPRISING NATURAL SWEETENER COMBINATIONS AND FOOD AND BEVERAGE PRODUCTS COMPRISING SAME

(71) Applicant: Nexba IP Pty Ltd, Sydney (AU)

(72) Inventors: Drew Benjamin Bilbe, Beacon Hill (AU); Troy Alexander Findlay Douglas, Dee Why (AU)

(21) Appl. No.: 17/807,785

(22) Filed: Jun. 20, 2022

Related U.S. Application Data
(63) Continuation of application No. 16/463,630, filed on May 23, 2019, now abandoned.
(60) Provisional application No. 62/426,852, filed on Nov. 28, 2016.

(51) Int. Cl. A23L 27/30; A23L 27/12; A23L 2/60

(52) U.S. Cl. CPC A23L 27/34; A23L 27/12; A23L 27/36; A23L 2/60; A23V 2002/00

(57) ABSTRACT

Provided herein are natural sweetener combinations for use in the manufacture of ingestible products, typically foods and beverages, wherein the natural sweetener combinations comprise or consist of two or more of a stevia extract, a sugar alcohol and monk fruit extract. Also provided are ingestible products, typically foods and beverages, containing said natural sweetener combinations.

### CROSS-REFERENCE TO RELATED APPLICATIONS

This application is a Continuation of and claims the benefit and priority to U.S. patent application Ser. No. 16/463,630, filed on May 23, 2019, which is a U.S. National Phase Application of PCT International Application Number PCT/AU2017/051305, filed on Nov. 28, 2017, designating the United States of America and published in the English language, which is an International Application of and claims the benefit of priority to U.S. Provisional Application No. 62/426,852, filed on Nov. 28, 2016. The entire contents of the above referenced applications are hereby expressly incorporated by reference in their entireties. Any and all priority claims identified in the Application Data Sheet, or any correction thereto, are hereby incorporated by reference under 37 CFR 1.57.

### FIELD OF THE ART

The present disclosure relates generally to natural sweetener compositions comprising combinations of two or more natural sweeteners selected from a stevia extract, a sugar alcohol, typically erythritol, and monk fruit extract. The disclosure also relates to foods, beverages and other ingestible products comprising such natural sweetener compositions.

### BACKGROUND

Many commonly consumed food and beverage products are high in sugar. This sugar not only supplies sweetness to the product, but also contributes to a favourable sensory response, for example in terms of the quality of sweetness, a lack of bitterness and off taste, and a desirable mouthfeel.

However significant health problems are associated with the consumption of products high in sugar, such as obesity, metabolic disease, heart disease and dental caries. These problems have led to the introduction of sugar substitutes and artificial sweeteners, such as aspartame, sucralose and saccharin, into a variety of foods and beverage products, which are often marketed as “diet” or “sugar-free”. However these sugar substitutes and artificial sweeteners may also be associated with health concerns and typically fail to provide the same taste profile and mouthfeel as sugar. Additionally, there is a growing demand from consumers for healthier alternative foods and beverages comprising natural ingredients and that are sugar free.

Of increasing interest are natural sweetener alternatives and the development of a range of foods and beverages containing natural sweeteners to meet this growing demand. Two such natural sweeteners are stevia extract and the sugar alcohol erythritol. Stevia extract is a source of steviol glycosides which are responsible for the sweet taste of the leaves of the stevia plant (Stevia rebaudiana). Steviol glycosides range in sweetness from 40 to 300 times sweeter than sucrose (table sugar) and are also characterized as being heat-stable, pH-stable, and non-fermentable. Erythritol is a low-molecular weight sugar alcohol with a glycemic index of zero and a sweetness approximately 70% of that of table sugar.

However to date products containing natural sweeteners have largely failed to mimic the desirable properties of sugar-containing products. In particular they typically possess either an unpleasant taste, taste not equivalent to that of sugar, or an unpleasant mouthfeel.

There is a need for the development of improved natural sweetener-containing compositions, and products comprising same, with desirable characteristics.

The present disclosure is predicated upon the inventors' development of novel compositions comprising two or more natural sweeteners that overcome the above-noted deficiencies.

### SUMMARY OF THE DISCLOSURE

In one aspect the present disclosure provides a natural sweetener combination for use in the manufacture of an ingestible product, wherein the natural sweetener combination comprises or consists of two or more of a stevia extract, a sugar alcohol and monk fruit extract.

Typically the sugar alcohol is erythritol. Typically the combination does not comprise sugar or artificial sweeteners. Typically the ingestible product does not comprise sugar or artificial sweeteners. In particular embodiments the ingestible product is a food or beverage.

In an embodiment, the natural sweetener combination comprises or consists of a stevia extract and erythritol, wherein the stevia extract represents from about 0.15% by weight of the combination to about 0.25% by weight of the combination and the erythritol represents greater than 99% by weight of the combination.

In an embodiment, the natural sweetener combination comprises or consists of a stevia extract and erythritol, wherein the stevia extract is present in the ingestible product in an amount from about 0.005% by weight to about 0.06% by weight based on the total weight of the product and the erythritol is present in the ingestible product in an amount from about 2.5% by weight to about 9% by weight based on the total weight of the product. Optionally the stevia extract may be present in an amount from about 0.006% by weight to about 0.05% by weight, from about 0.007% by weight to about 0.025% by weight, or from about 0.007% by weight to about 0.014% by weight based on the total weight of the product. Optionally the erythritol may be present in an amount from about 3.5% by weight to about 7% by weight, from about 3.5% by weight to about 5% by weight, or form about 5.5% by weight to about 7% by weight based on the total weight of the product.

In an embodiment, the natural sweetener combination comprises or consists of a stevia extract, erythritol and a monk fruit extract. In such embodiments, the stevia extract may be present in the ingestible product in an amount from about 0.005% by weight to about 0.06% by weight, optionally from about 0.03% by weight to about 0.05% by weight, based on the total weight of the product, the erythritol may be present in the ingestible product in an amount from about 2.5% by weight to about 5.5% by weight, optionally from about 3.5% by weight to about 5% by weight, based on the total weight of the product and the monk fruit extract may be present in the ingestible product in an amount from about 0.005% by weight to about 0.05% by weight, optionally from about 0.01% by weight to about 0.04% by eight, based on the total weight of the product.

In a further aspect the present disclosure provides a natural sweetener combination for use in the manufacture of an ingestible product, wherein the natural sweetener combination comprises or consists of a stevia extract and a sugar alcohol, wherein the stevia extract represents from about 0.15% by weight of the combination to about 0.25% by weight of the combination and the erythritol represents greater than 99% by weight of the combination.

Typically the sugar alcohol is erythritol. Typically the combination does not comprise sugar or artificial sweeteners. Typically the ingestible product does not comprise sugar or artificial sweeteners. In particular embodiments the ingestible product is a food or beverage.

In an embodiment, the stevia extract is present in the ingestible product in an amount from about 0.005% by weight to about 0.06% by weight based on the total weight of the product and the sugar alcohol is present in the ingestible product in an amount from about 2.5% by weight to about 9% by weight based on the total weight of the product. Optionally the stevia extract may be present in an amount from about 0.006% by weight to about 0.05% by weight, from about 0.007% by weight to about 0.025% by weight, or from about 0.007% by weight to about 0.014% by weight based on the total weight of the product. Optionally the sugar alcohol may be present in an amount from about 3.5% by weight to about 7% by weight, from about 3.5% by weight to about 5% by weight, or form about 5.5% by weight to about 7% by weight based on the total weight of the product.

In a further aspect the present disclosure provides a natural sweetener combination for use in the manufacture of an ingestible product, wherein the natural sweetener combination comprises or consists of a stevia extract and a sugar alcohol, and wherein the stevia extract is present in the ingestible product in an amount from about 0.007% by weight to about 0.014% by weight based on the total weight of the product and the sugar alcohol is present in the ingestible product in an amount from about 5.5% by weight to about 7% by weight based on the total weight of the product.

Typically the sugar alcohol is erythritol. Typically the combination does not comprise sugar or artificial sweeteners. Typically the ingestible product does not comprise sugar or artificial sweeteners. In particular embodiments the ingestible product is a food or beverage.

In a further aspect the present disclosure provides a natural sweetener combination for use in the manufacture of an ingestible product, wherein the natural sweetener combination comprises or consists of a stevia extract, a sugar alcohol and a monk fruit extract, wherein the stevia extract is present in the ingestible product in an amount from about 0.005% by weight to about 0.06% by weight, optionally from about 0.03% by weight to about 0.05% by weight, based on the total weight of the product, the sugar alcohol is present in the ingestible product in an amount from about 2.5% by weight to about 5.5% by weight, optionally from about 3.5% by weight to about 5% by weight, based on the total weight of the product and the monk fruit extract is present in the ingestible product in an amount from about 0.005% by weight to about 0.05% by weight, optionally from about 0.01% by weight to about 0.04% by eight, based on the total weight of the product.

Typically the sugar alcohol is erythritol. Typically the combination does not comprise sugar or artificial sweeteners. Typically the ingestible product does not comprise sugar or artificial sweeteners. In particular embodiments the ingestible product is a food or beverage.

In a further aspect, there is provided an ingestible product comprising a natural sweetener combination according to the present disclosure.

The ingestible product may be a food or beverage. In an exemplary embodiment, the beverage is a carbonated beverage.

In an exemplary embodiment, the ingestible product is a beverage, and the beverage is produced using a process including cold-sterilization using dimethyl dicarbonate.

In a further aspect there is provided a carbonated beverage comprising a natural sweetener combination according to the present disclosure.

In a further aspect there is provided an ingestible product comprising a natural sweetener combination, wherein the natural sweetener combination comprises or consists of a stevia extract and a sugar alcohol, and wherein the stevia extract is present in the ingestible product in an amount from about 0.005% by weight to about 0.06% by weight based on the total weight of the product and the sugar alcohol is present in the ingestible product in an amount from about 2.5% by weight to about 9% by weight based on the total weight of the product.

Optionally the stevia extract may be present in an amount from about 0.006% by weight to about 0.05% by weight, from about 0.007% by weight to about 0.025% by weight, or from about 0.007% by weight to about 0.014% by weight based on the total weight of the product. Optionally the sugar alcohol may be present in an amount from about 3.5% by weight to about 7% by weight, from about 3.5% by weight to about 5% by weight, or form about 5.5% by weight to about 7% by weight based on the total weight of the product.

Typically the sugar alcohol is erythritol. In an embodiment, the ingestible product is a food or beverage. The beverage may be a carbonated beverage.

In a further aspect there is provided an ingestible product comprising a natural sweetener combination, wherein the natural sweetener combination comprises or consists of a stevia extract, a sugar alcohol and a monk fruit extract, and wherein the stevia extract is present in the ingestible product in an amount from about 0.005% by weight to about 0.06% by weight, optionally from about 0.03% by weight to about 0.05% by weight, based on the total weight of the product, the sugar alcohol is present in the ingestible product in an amount from about 2.5% by weight to about 5.5% by weight, optionally from about 3.5% by weight to about 5% by weight, based on the total weight of the product and the monk fruit extract is present in the ingestible product in an amount from about 0.005% by weight to about 0.05% by weight, optionally from about 0.01% by weight to about 0.04% by eight, based on the total weight of the product.

Typically the sugar alcohol is erythritol. In an embodiment, the ingestible product is a food or beverage. The beverage may be a carbonated beverage.

In a further aspect there is provided the use of a natural sweetener combination according to the present disclosure in the manufacture of an ingestible product, optionally a food or beverage.

In a further aspect there is provided the use of a natural sweetener combination according to the present disclosure as a sugar substitute.

### DETAILED DESCRIPTION

Unless defined otherwise, all technical and scientific terms used herein have the same meaning as commonly understood by those of ordinary skill in the art to which the disclosure belongs. Although any methods and materials similar or equivalent to those described herein can be used in the practice or testing of the present disclosure, typical methods and materials are described.

The articles “a” and “an” are used herein to refer to one or to more than one (i.e., to at least one) of the grammatical object of the article. By way of example, “an element” means one element or more than one element.

In the context of this specification, the term “about,” is understood to refer to a range of numbers that a person of skill in the art would consider equivalent to the recited value in the context of achieving the same function or result.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

In the context of this specification, the term “sugar” refers to not only sucrose (table sugar) but also includes chemically and structurally related carbohydrates including glucose, fructose, and the like.

In the context of this specification, the term “probiotic” is to be given its broadest construction and is understood to refer to a microbial cell population or preparation, or component of a microbial cell population or preparation, which when administered to a subject in an effective amount promotes a health benefit in the subject.

In the context of this specification, the term “prebiotic” is to be given its broadest construction and is understood to refer to any non-digestible substance that stimulates the growth and/or activity of bacteria in the digestive system.

The term “optionally” is used herein to mean that the subsequently described feature may or may not be present or that the subsequently described event or circumstance may or may not occur. Hence the specification will be understood to include and encompass embodiments in which the feature is present and embodiments in which the feature is not present, and embodiments in which the event or circumstance occurs as well as embodiments in which it does not.

Provided herein are natural sweetener combinations which find use as sugar substitutes and in particular in the manufacture of ingestible products such as foods and beverages.

Accordingly, provided herein are natural sweetener combinations comprising or consisting of two or more of a sugar alcohol, a stevia extract and a monk fruit extract. Typically the natural sweetener combinations comprise a sugar alcohol and a stevia extract.

Sugar alcohols, also known as polyols, polyhydric alcohols, or polyalcohols, are the hydrogenated forms of the aldoses or ketoses of a sugar. The sugar alcohol may be selected from erythritol, mannitol, sorbitol, arabitol, threitol, xylitotl, ribitol, galactitol, fruitol, iditol, inositol, volemitol, lactitol, malitol, or combinations thereof. In specific embodiments of the present disclosure, the sugar alcohol is erythritol. A variety of suitable commercially available sources of erythritol are well known to those skilled in the art and may be employed in accordance with the present disclosure.

The stevia extract may be any extract of the Stevia plant, typically the leaves, that contains one or more of the steviol glycosides which are responsible for the sweet taste of the leaves of the stevia plant. These glycosides include, but are not limited to, stevioside, steviobioside, rebaudioside A, rebaudioside B, rebaudioside C, rebaudioside D, rebaudioside E, and dulcoside A. A variety of suitable commercially available stevia extracts are well known to those skilled in the art and may be employed in accordance with the present disclosure. One exemplary suitable stevia extract is RA97 (Biolotus Technology Jiangsu Inc.), a highly purified stevia extract containing rebaudioside A (MW: 967.03), a white hygroscopic powder, freely soluble in water and colourless in solution.

Monk fruit is obtained from the plant Siraitia grosvenorii, a herbaceous perennial vine of the Cucurbitaceae (gourd) family. The monk fruit extract may be any extract derived from the fruit of the monk fruit vine which contains one or more mogrosides. A variety of suitable commercially available monk fruit extracts are well known to those skilled in the art and may be employed in accordance with the present disclosure.

In particular embodiments of the present disclosure, the natural sweetener combination comprises or consists of a stevia extract and erythritol, wherein the stevia extract represents from about 0.15% by weight of the combination to about 0.25% by weight of the combination and the erythritol represents greater than 99% by weight of the combination. The stevia extract may represent, for example, about 0.155%, 0.160%, 0.165%, 0.170%, 0.175%, 0.180%, 0.185%, 0.190%, 0.195%, 0.200%, 0.205%, 0.210%, 0.215%, 0.220%, 0.225%, 0.230%, 0.235%, 0.240%, 0.245%, or 0.250% by weight of the combination.

In particular embodiments of the present disclosure, the natural sweetener combination comprises or consists of a stevia extract and a sugar alcohol, optionally erythritol, wherein the stevia extract is present in an ingestible product containing the combination in an amount from about 0.005% by weight to about 0.06% by weight based on the total weight of the product and the sugar alcohol is present in the ingestible product in an amount from about 2.5% by weight to about 9% by weight based on the total weight of the product. In optional embodiments, the stevia extract may be present in an amount from about 0.006% by weight to about 0.05% by weight, from about 0.007% by weight to about 0.025% by weight, or from about 0.007% by weight to about 0.014% by weight based on the total weight of the product. In optional embodiments the sugar alcohol may be present in an amount from about 3.5% by weight to about 7% by weight, from about 3.5% by weight to about 5% by weight, or form about 5.5% by weight to about 7% by weight based on the total weight of the product.

For example, the stevia extract in the natural sweetener combination may be present in the ingestible product containing the combination in an amount of about 0.005%, 0.006%, 0.007%, 0.008%, 0.009%, 0.010%, 0.0110%, 0.0120%, 0.0130%, 0.0140%, 0.015%, 0.016%, 0.017%, 0.018%, 0.019%, 0.02%, 0.021%, 0.022%, 0.023%, 0.024%, 0.025%, 0.026%, 0.027%, 0.028%, 0.029%, 0.03%, 0.031%, 0.032%, 0.033%, 0.034%, 0.035%, 0.036%, 0.037%, 0.038%, 0.039%, 0.04%, 0.041%, 0.042%, 0.043%, 0.044%, 0.045%, 0.046%, 0.047%, 0.048%, 0.049%, 0.05%, 0.051%, 0.052%, 0.053%, 0.054%, 0.055%, 0.056%, 0.057%, 0.058%, 0.059% or 0.06% by weight based on the total weight of the product.

For example, the sugar alcohol, optionally erythritol, in the natural sweetener combination may be present in the ingestible product containing the combination in an amount of about 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, 5.1%, 5.2%, 5.3%, 5.4%, 5.5%, 5.6%, 5.7%, 5.8%, 5.9%, 6.0%, 6.1%, 6.2%, 6.3%, 6.4%, 6.5%, 6.6%, 6.7%, 6.8%, 6.9%, 7.0%, 7.1%, 7.2%, 7.3%, 7.4%, 7.5%, 7.6%, 7.7%, 7.8%, 7.9%, 8.0%, 8.1%, 8.2%, 8.3%, 8.4%. 8.5%, 8.6%, 8.7%, 8.8%, 8.9% or 9.0% by weight based on the total weight of the product.

The natural sweetener combination may further comprise monk fruit extract present in an ingestible product comprising the combination in an amount from about 0.005% by weight to about 0.05% by weight, optionally from about 0.01% by weight to about 0.04% by weight, based on the total weight of the product. The monk fruit extract in the natural sweetener combination may be present in the ingestible product containing the combination in an amount of about 0.005%, 0.006%, 0.007%, 0.008%, 0.009%, 0.01%, 0.011%, 0.012%, 0.013%, 0.014%, 0.015%, 0.016%, 0.017%, 0.018%, 0.019%, 0.02%, 0.021%, 0.022%, 0.023%, 0.024%, 0.025%, 0.026%, 0.027%, 0.028%, 0.029%, 0.03%, 0.031%, 0.032%, 0.033%, 0.034%, 0.035%, 0.036%, 0.037%, 0.038%, 0.039%, 0.04%, 0.041%, 0.042%, 0.043%, 0.044%, 0.045%, 0.046%, 0.047%, 0.048%, 0.049% or 0.05% by weight based on the total weight of the product.

In a particular embodiment, the natural sweetener combination comprises a stevia extract and erythritol, wherein the stevia extract is present in an ingestible product containing the combination in an amount from about 0.007% by weight to about 0.014% by weight based on the total weight of the product and the sugar alcohol is present in the ingestible product in an amount from about 5.5% by weight to about 7% by weight based on the total weight of the product. Optionally, in this embodiment the natural sweetener combination does not comprise monk fruit extract.

In an alternative embodiment, the natural sweetener combination comprises stevia extract, wherein the stevia extract is present in an ingestible product containing the combination in an amount from about 0.007% by weight to about 0.06% by weight based on the total weight of the product, erythritol, wherein the erythritol in the natural sweetener combination is present in the ingestible product containing the combination in an amount from about 2.5% by weight to about 5.5% by weight based on the total weight of the product, and a monk fruit extract, wherein the monk fruit extract is present in the ingestible product in an amount form about 0.005% by weight to about 0.05% by weight based on the total weight of the product. Optionally the stevia extract is present in the ingestible product in an amount from about 0.03% by weight to about 0.05% by weight based on the total weight of the product, the erythritol is present in the ingestible product in an amount from about 3.5% by weight to about 5% by weight based on the total weight of the product, and the monk fruit extract is present in the ingestible product in an amount from about 0.01% by weight to about 0.04% by eight based on the total weight of the product.

In this embodiment, the stevia extract in the natural sweetener combination may be present in the ingestible product containing the combination in an amount of about 0.007%, 0.008%, 0.009%, 0.01%, 0.012%, 0.014%, 0.016%, 0.018%, 0.02%, 0.022%, 0.024%, 0.026%, 0.028%, 0.03%, 0.032%, 0.034%, 0.036%, 0.038%, 0.04%, 0.042%, 0.044%, 0.046%, 0.048% or 0.0.05% by weight based on the total weight of the product.

In this embodiment, the erythritol in the natural sweetener combination may be present in the ingestible product containing the combination in an amount of about 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, 5.1%, 5.2%, 5.3%, 5.4% or 5.5% by weight based on the total weight of the product.

In this embodiment, the monk fruit extract in the natural sweetener combination may be present in the ingestible product containing the combination in an amount of about 0.005%, 0.006%, 0.007%, 0.008%, 0.009%, 0.01%, 0.011%, 0.012%, 0.013%, 0.014%, 0.015%, 0.016%, 0.017%, 0.018%, 0.019%, 0.02%, 0.021%, 0.022%, 0.023%, 0.024%, 0.025%, 0.026%, 0.027%, 0.028%, 0.029%, 0.03%, 0.031%, 0.032%, 0.033%, 0.034%, 0.035%, 0.036%, 0.037%, 0.038%, 0.039%, 0.04%, 0.041%, 0.042%, 0.043%, 0.044%, 0.045%, 0.046%, 0.047%, 0.048%, 0.049% or 0.05% by weight based on the total weight of the product.

The components of a natural sweetener combination according to the present disclosure may be combined into a single composition, with the components combined in any order and the composition prepared using any suitable methodology. For example the natural sweetener combination may be formed into a particulate/powder material using techniques such as fluid bed agglomeration. Similarly, ingestible products containing natural sweetener combinations of the present disclosure may be produced using any process or methodology known in the art. Such processes and methodologies will depend upon the nature of the product being produced. In some instances, the process for production of the product may include a step of cold-sterilization, optionally using chemical cold-sterilization using, for example, dimethyl dicarbonate (DMDC).

The natural sweetener combination, or more typically, an ingestible product comprising the natural sweetener combination may comprise one or more flavours. Typically such flavours are natural flavours to create an enhancing flavour profile for the product. Such flavour profiles may include, for example: cola; citrus fruit; berry; orange; lemon; lime; tangerine; mandarin; grapefruit; grape; pear; passionfruit; pineapple; banana; apple; cranberry; cherry; raspberry; strawberry; peach; plum; currant; blackcurrant; blackberry; pomegranate; goji berry; rosehip; rooibos; watermelon; honeydew; mango; papaya; tea (e.g. green tea or black tea); coffee; vanilla; almond; vegetable; tomato; celery; cucumber; spinach; carrot; or combinations thereof. The flavour or flavours employed to produce the desired flavour profile may comprise, for example, one or more oils or natural extracts and may be employed in any amount suitable to produce the desired flavour profile. Such determination is well within the abilities and skills of the skilled addressee, without need for further experimentation or invention.

Depending on the nature of the ingestible product containing the natural sweetener combination, the product may contain one or more bulking agents. The bulking agents may be any suitable bulking agent known to those skilled in the art. Examples which may be contemplated include maltodextrin, polydextrose, gums (such as xanthan gum or guar gum), soluble corn fiber (SCF), starches and polyols, or mixtures thereof. The amount of the at least one bulking agent will depend primarily on the type of product produced employing the natural sweetener combination and the functional properties required for that product (e.g. whether the product is a food or beverage, solid or liquid and the desired consistency, viscosity and chewability of the product). In the case of beverages produced using natural sweetener combinations of the present disclosure, water, milk, fruit juice or other liquid may be considered as a bulking agent.

In general, the amount of bulking agent present in the product may be from about 5% by weight to about 95% by weight relative to the total weight of the natural sweetener combination used in the product, for example in an amount of from about 20% to about 95% by weight, or from about 50% to about 90% by weight relative to the total weight of the natural sweetener combination. The amount of suitable bulking agent to be employed can be determined by the skilled addressee without need for further experimentation or invention.

The natural sweetener combination, or more typically, an ingestible product comprising the natural sweetener combination may additionally comprise additives, flavour enhancers, colours or colour enhancers, mouthfeel enhancers, antioxidants, binders, preservatives or other ingredients. In particular embodiments ingestible products containing natural sweetener combinations of the present disclosure are preservative-free.

Natural sweetener combinations according to the present disclosure may be provided in solid (e.g. powder or crystalline) form, or in liquid form (e.g. as a syrup) for subsequent use in the manufacture of a range of ingestible products, including beverages and foods. Foods and beverages may be intended for consumption by humans or animals. Where a food or beverage is intended for consumption by subjects other than humans, the term can be used to include a feedstuff.

Beverages employing natural sweetener combinations of the present disclosure may be, for example, carbonated and non-carbonated beverages, alcoholic and non-alcoholic beverages, ready-to-drink beverages, beverage mixes and concentrates (including dry powder premixes). Exemplary beverages include, but are not limited to, soft drinks, sports drinks, isotonic beverages, alcoholic beverages such as beers, ciders and wines, fruit juice and juice drinks, bottled water, iced tea, iced coffee, milk and other dairy beverages, probiotic-containing liquid supplements.

Foods employing natural sweetener combinations of the present disclosure include, for example, snack foods, health foods, confectionary, ice confectionary, baked goods, ready meals, pre-packaged frozen foods, and tinned foods. Examples of suitable foods include, but are not limited to, health bars, protein and energy bars, muesli bars, breakfast cereals, pre-prepared fruit snack foods, cakes, pies, biscuits, cookies, muffins, pastries, breads, bagels, chewing gum, confectionaries including chocolate bars and hard and soft candies, ice cream, water ice blocks, fruit-based ice blocks, frozen yoghurt, yoghurt and other dairy products, jellies, flavoured straws, puddings and condiments such as spreads, sauces, dressings, marinades and jams.

Examples of non-food or beverage ingestible products that may employ natural sweetener combinations of the present disclosure include, but are not limited to, probiotic and prebiotic formulations, compositions or supplements, and nutraceutical products.

Compositions of the present disclosure may be conveniently incorporated in a variety of food and/or beverage products, nutraceutical products, probiotic supplements, food additives, pharmaceuticals and over-the-counter formulations. The food or food additive may be a solid form such as a powder, or a liquid form. Specific examples of the types of beverages or foods include, but are not limited to water-based, milk-based, yoghurt-based, other dairy-based, milk-substitute based such as soy milk or oat milk, or juice-based beverages, water, soft drinks, carbonated drinks, and nutritional beverages, (including a concentrated stock solution of a beverage and a dry powder for preparation of such a beverage); baked products such as crackers, breads, muffins, rolls, bagels, biscuits, cereals, bars such as muesli bars, health food bars and the like, dressings, sauces, custards, yoghurts, puddings, pre-packaged frozen meals, soups and confectioneries.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

The present disclosure will now be described with reference to the following specific examples, which should not be construed as in any way limiting the scope of the invention.

### EXAMPLES

The following examples are illustrative of the invention and should not be construed as limiting in any way the general nature of the disclosure of the description throughout this specification.

### Example 1—Cola Flavoured Beverage Comprising a Natural Sweetener Combination

An exemplary cola-flavoured carbonated beverage in accordance with the present disclosure comprises the following ingredients:

TABLE 1

| Ingredient | Quantity | |
|---|---|---|
| Erythritol | 62.171 | kg |
| Stevia extract | 0.140 | kg |
| Natural flavours | 0.788 | kg |
| Natural colours (hazelnut brown, black carrot) | 1.700 | kg |
| Ascorbic acid | 0.800 | kg |
| Citric acid anhydrous | 0.484 | kg |
| RO water | 933.92 | L |
| Total | 1000 | L |

The liquid formulation has the following properties:

TABLE 2
Standard specifications

| | | | Beverage specification | |
|---|---|---|---|---|
| Parameter | Syrup specification | | & tolerances | |
| Brix (°) | 23.4 | (±0.7) | 6.28 | (±0.2) |
| Specific Gravity | 1.0820 | (±0.01) | 1.0206 | (±0.002) |
| pH | — | | 2.890 | (±0.1) |
| Acidity | 0.304 | (±0.08) | 0.076 | (±0.02) |
| (% w/v citric acid) | | | | |

| Carbonation (vols) | — | 3.60 | (±0.2) |
|---|---|---|---|
| Turbidity (NTU) | — | <10 | |
| Spectrometer @ | — | 1.082 | (±0.2) |
| 242 nm (abs) | | | |
| Spectrometer @ | — | 0.200 | (±0.2) |
| 560 nm (abs) | | | |
| Velcorin | Absent | Present (190 ppm ± 10) | |
| (present/absent) | | | |
| Shelf Life (days) | 3 | 365 | |
| Oxygen (ppm) | — | <1 | |
| Air (mL) | — | <3 | |
| Total Plate Count | NA | <100 | CFU/mL |
| (CFU/mL) | | | |
| Yeast (CFU/mL) | NA | <10 | CFU/mL |
| Mould (CFU/mL) | NA | <10 | CFU/mL |

| | |
|---|---|
| Allergen | Nil |
| Mandatory Advisory | Nil |
| Statements | |

### Example 2—Lemon Flavoured Beverage Comprising a Natural Sweetener Combination

An exemplary lemon-flavoured carbonated beverage in accordance with the present disclosure comprises the following ingredients:

TABLE 3

| Ingredient | Quantity | |
|---|---|---|
| Erythritol | 60.000 | kg |
| Stevia extract | 0.110 | kg |
| Natural flavours | 2.695 | kg |
| Natural colours (hazelnut brown) | 0.040 | kg |
| Citric acid anhydrous | 2.700 | kg |
| RO water | 934.47 | L |
| Total | 1000 | L |

The liquid formulation has the following properties:

TABLE 4
Standard Specifications

| | | | Beverage specification | |
|---|---|---|---|---|
| Parameter | Syrup specification | | & tolerances | |
| Brix (°) | 23.1 | (±0.7) | 6.2 | (±0.2) |
| Specific Gravity | 1.0828 | (±0.01) | 1.0207 | (±0.002) |
| pH | — | | 2.57 | (±0.1) |
| Acidity | 1.216 | (±0.08) | 0.304 | (±0.02) |
| (% w/v citric acid) | | | | |

| Carbonation (vols) | — | 3.60 | (±0.2) |
|---|---|---|---|
| Turbidity (NTU) | — | 55.0 | (±10) |
| Spectrometer @ | — | 0.330 | (±0.01) |
| 550 (abs) nm | | | |
| Velcorin | Absent | Present (190 ppm ± 10) | |
| (present/absent) | | | |
| Shelf Life (days) | 3 | 365 | |
| Oxygen (ppm) | — | <1 | |
| Air (mL) | — | <3 | |
| Total Plate Count | NA | <100 | CFU/mL |
| (CFU/mL) | | | |
| Yeast (CFU/mL) | NA | <10 | CFU/mL |
| Mould (CFU/mL) | NA | <10 | CFU/mL |

| | |
|---|---|
| Allergen | Nil |
| Mandatory Advisory | Nil |
| Statements | |

### Example 3—Orange Flavoured Beverage Comprising a Natural Sweetener Combination

An exemplary orange-flavoured carbonated beverage in accordance with the present disclosure comprises the following ingredients:

TABLE 5

| Ingredient | Quantity | |
|---|---|---|
| Erythritol | 56.991 | kg |
| Stevia extract | 0.110 | kg |
| Natural flavours | 2.159 | kg |
| Natural colours (black carrot, paprika extract) | 0.287 | kg |
| Citric acid anhydrous | 2.000 | kg |
| RO water | 938.45 | L |
| Total | 1000 | L |

The liquid formulation has the following properties:

TABLE 6
Standard Specifications

| | | | Beverage specification | |
|---|---|---|---|---|
| Parameter | Syrup specification | | & tolerances | |
| Brix (°) | 21.7 | (±0.7) | 5.8 | (±0.2) |
| Specific Gravity | 1.0772 | (±0.01) | 1.0193 | (±0.002) |
| pH | — | | 2.645 | (±0.1) |
| Acidity | 0.908 | (±0.08) | 0.227 | (±0.02) |
| (% w/v citric acid) | | | | |

| Carbonation (vols) | — | 3.60 | (±0.2) |
|---|---|---|---|
| Turbidity (NTU) | — | 385.0 | (±10) |
| Spectrometer @ | — | 0.760 | (±0.1) |
| 550 (abs) nm | | | |
| Spectrometer @ | — | 0.480 | (±0.1) |
| 560 (abs) nm | | | |
| Velcorin | Absent | Present (190 ppm ± 10) | |
| (present/absent) | | | |
| Shelf Life (days) | 3 | 365 | |
| Oxygen (ppm) | — | <1 | |
| Air (mL) | — | <3 | |
| Total Plate Count | NA | <100 | CFU/mL |
| (CFU/mL) | | | |
| Yeast (CFU/mL) | NA | <10 | CFU/mL |
| Mould (CFU/mL) | NA | <10 | CFU/mL |

| | |
|---|---|
| Allergen | Nil |
| Mandatory Advisory | Nil |
| Statements | |

1. (canceled)

2. A natural sweetener combination comprising two or more of a stevia extract, a sugar alcohol or a monk fruit extract.

3. The natural sweetener combination of claim 2, wherein the sugar alcohol is erythritol.

4. The natural sweetener combination of claim 2, comprising or consisting of a stevia extract, erythritol and a monk fruit extract.

5. The natural sweetener combination of claim 4, wherein the stevia extract is incorporated into an ingestible product in an amount from about 0.007% by weight to about 0.014% by weight based on the total weight of the product and the erythritol is present in the ingestible product in an amount from about 2.5% by weight to about 5% by weight based on the total weight of the product.

6. The natural sweetener combination of claim 2, wherein the natural sweetener combination comprises or consists of a stevia extract and a sugar alcohol, wherein the stevia extract represents from about 0.15% by weight of the combination to about 0.25% by weight of the combination and the sugar alcohol represents greater than 99% by weight of the combination.

7. The natural sweetener combination of claim 6, wherein the sugar alcohol is erythritol.

8. The natural sweetener combination of claim 2, wherein the natural sweetener combination comprises or consists of a stevia extract and a sugar alcohol, and wherein the stevia extract is incorporated into an ingestible product in an amount from about 0.007% by weight to about 0.014% by weight based on the total weight of the product and the sugar alcohol is present in the ingestible product in an amount from about 5.5% by weight to about 7% by weight based on the total weight of the product.

9. The natural sweetener combination of claim 8, wherein the sugar alcohol is erythritol.

10. The natural sweetener combination of claim 2, wherein the natural sweetener combination comprises or consists of a stevia extract, a sugar alcohol and a monk fruit extract, wherein the stevia extract is incorporated into an ingestible product in an amount from about 0.03% by weight to about 0.05% by weight based on the total weight of the product, the sugar alcohol is incorporated into the ingestible product in an amount from about 3.5% by weight to about 5% by weight based on the total weight of the product, and the monk fruit extract is incorporated into the ingestible product in an amount from about 0.01% by eight to about 0.04% by weight based on the total weight of the product.

11. The natural sweetener combination of claim 10, wherein the sugar alcohol is erythritol.

12. The natural sweetener combination of claim 2, wherein the natural sweetener combination does not contain sugar or artificial sweeteners.

13. The natural sweetener combination of claim 2, wherein the ingestible product does not contain sugar or artificial sweeteners.

14. The natural sweetener combination of claim 2, wherein the ingestible product is a food or beverage.

15. The natural sweetener combination of claim 14, wherein the beverage is a carbonated beverage.

16. An ingestible product comprising a natural sweetener combination according to claim 2.

17. The ingestible product of claim 16, wherein the product is a food or beverage.

18. The ingestible product of claim 17, wherein the beverage is a carbonated beverage.

19. The ingestible product of claim 17, wherein the product is a beverage and the beverage is produced using a process including cold-sterilization using dimethyl dicarbonate.

20. A method of using the natural sweetener combination according to claim 2 as a sugar substitute comprising incorporating the natural sweetner combination of claim 2 into a food or beverage.
